(19) United States
(12) Patent Application Publication
(10) Pub. No.: US 2013/0137524 A1
(43) Pub. Date: May 30, 2013

(54) Seated Gaming Device and Workstation

(71) Applicant: Deana Scott, North Bend, OR (US)

(72) Inventor: Deana Scott, North Bend, OR (US)

(21) Appl. No.: 13/160,631

(22) Filed: Jun. 15, 2011

(51) Int. Cl. A63F 13/08

(52) U.S. Cl. CPC A63F 13/08
USPC 463/47

(57) ABSTRACT

Disclosed is a gaming cabinet comprising a chair having a seat, a removable pillow cushion; a back, and at least a one arm, said arm being detachable from the chair and being configured to support all components of a video gambling game; a video display rotatably attached to the arm; a console located on the top surface of the arm; an access door on the top surface of the arm; and ticket in-ticket-out equipment located on the front surface of the arm. The gaming cabinet of may also include a second arm that may be permanently attached to the chair, cash acceptance and validation equipment located on the top surface of and contained within the detachable arm.

### FIELD OF THE DISCLOSURE

A modular gaming cabinet and seated gaming device to improve comfort and time of play on the device and to allow for a wide variety of games from all manufacturers to be interchangeably played on the device is disclosed.

### BACKGROUND OF THE INVENTION

Video slots, video poker and other video gambling games are a popular form of gaming in casinos. The video games are primarily presented for play in two styles of gaming machines or cabinets. One is a stand-up type machine where the player stands in front of the video display and the controls. The other is a slant type cabinet where the display and controls are lower allowing the player to be seated on a stool or small chair with a short back in front of the machine. In either case, the player is relatively uncomfortable—either standing or balancing on a stool or seated in a small rigid chair. Two of the many factors in determining the profitability of a particular set or bank of gaming machines are how many machines can be placed in a given amount of floor space and how long will a player play the machine. The more machines that can be placed into one area, the greater the profitability of the bank of machines in that area. Accordingly, most machines are placed side-by-side one another in rows and the rows are placed back-to-back. In this way, more machines can be placed in a given area. Likewise, the longer a player plays a machine, the greater the profitability of that machine.

Another issue faced by casino owners is that there are many different manufacturers of games in the casino gaming industry all providing a wide of variety of largely proprietary games. Each manufacturer typically provides its proprietary games in a proprietary stand-up type machine or slant type cabinet. Casinos typically employ a mix of games from various manufacturers on the casino floor and tus have a wide variety of cabinet types and sizes on the floor at any one time. Casinos oftentimes would like to move their mix of machines and games to different locations of the casino floor. For example, different crowds coming for varying conventions or shows often dictate that a different mix of machines at the front of the casino or by the showroom would increase profits with respect to that particular crowd. Or, some machines and games may simply not do well in a one location while they may thrive in another location. Other times, machines and games may be moved simply to keep the floor fresh and different. With the current stand-up type machines and slant type boxes in order to effect these moves, casinos must move entire machines and oftentimes entire banks of machines. What is needed is a modular gaming cabinet where only that portion of the cabinet incorporating the games themselves may be moved.

Disclosed herein is a seated gaming device designed to increase a player's time on the device. The features work together to allow a player complete comfort, convenience and machine side service therefore increasing the time that the player spends at the device and, therefore, the spend per player. It creates an environment that encourages a player to expand time on device driving additional gaming revenue. The gaming device disclosed herein can also be configured in a such a manner to allow the gaming device to be placed side-by-side in rows and the rows placed back-to-back so as to maximize the number of gaming devices that can be placed in a given floor area. The gaming device may also be specifically sized to minimize the footprint of the device and increase revenue per square foot and increase visibility. The design allows gaming operators to bank games easily to maximize gaming floor space. Although ideal for casino gaming environments, the device disclosed herein is not limited to such environments. For example, the device is also useful for non-gaming and home environments as, for example, email stations, workstations, hotels, coffee shops and home gaming applications. Used in these environments, the configuration and size of the device may be less important allowing for greater variety.

To address the issue of ease of moving the gaming cabinet, an embodiment of the device is shown wherein the one of the arms of the device is a detachable components housing unit containing all components required to provide a game to the player seated at the device. The detachable components housing unit includes all gaming components such as bill validators, ticketing, video display, speakers, cashless gaming, game control buttons and devices, etc. The detachable components housing unit could also include charging stations, call buttons, additional sound systems beyond that needed for game play and the like. Those additional components cabinet could also be retained in the device itself. The detachable components housing unit is essentially a gaming cabinet containing any game provided by any manufacturer of games. The detachable housing components unit is configured to be easily removed and reattached to the device so that the game contained within the detachable housing components unit is easily moved from one device to another within the casino, without having to move the entire device.

### SUMMARY OF INVENTION

Disclosed herein is a gaming cabinet comprising including a chair having a seat, a back, and at least one arm. The single arm is detachable from the chair and configured to support the components of a video gambling game. The gaming cabinet may further include a second arm, wherein the second arm may be permanently attached to the chair. In some embodiments the seat of the gaming cabinet may be removable, for example, a pillow cushion.

Also disclosed is a gaming cabinet comprising a chair having a seat, a back, and at least one arm being detachable from the chair. A video display is attached to the chair and the detachable arm is configured to support the components of a video gambling game. In some embodiments the video display is attached to the detachable arm. In a preferable embodiment, the video display is rotatably attached to the detachable arm. The gaming cabinet may also include a console located on the top surface of the detachable arm. The detachable arm preferably includes an access door on the top surface of the arm and ticket-in/ticket out equipment located on the front surface of the arm. As above, the seat may be removable pillow cushion. In other embodiments, the gaming cabinet also includes a second arm that may be permanently attached to the chair.

Also disclosed is a gaming cabinet comprising a chair having a seat, a removable pillow cushion; a back, and at least a one arm, said arm being detachable from the chair and being configured to support all components of a video gambling game; a video display rotatably attached to the arm; a console located on the top surface of the arm; an access door on the top surface of the arm; and ticket in-ticket-out equipment located on the front surface of the arm. The gaming cabinet of may also include a second arm that may be permanently attached to the chair, cash acceptance and validation equipment located on the top surface of and contained within the detachable arm.

### BRIEF DESCRIPTION OF THE DRAWINGS

FIG. 1 illustrates a first view of a first example of a seated gaming device in accordance with certain embodiments of the disclosed technology.

FIG. 2 illustrates a second view of the first example of a seated gaming device.

FIG. 3 illustrates a third view of the first example of a seated gaming device.

FIG. 4 illustrates an example of a plurality of seated gaming devices in accordance with certain embodiments of the disclosed technology.

FIG. 5 illustrates a first view of a second example of a seated gaming device in accordance with certain embodiments of the disclosed technology.

FIG. 6 illustrates a second view of the second example of a seated gaming device.

FIG. 7 illustrates a third view of the second example of a seated gaming device.

FIG. 8 illustrates a fourth view of the second example of a seated gaming device.

### DESCRIPTION

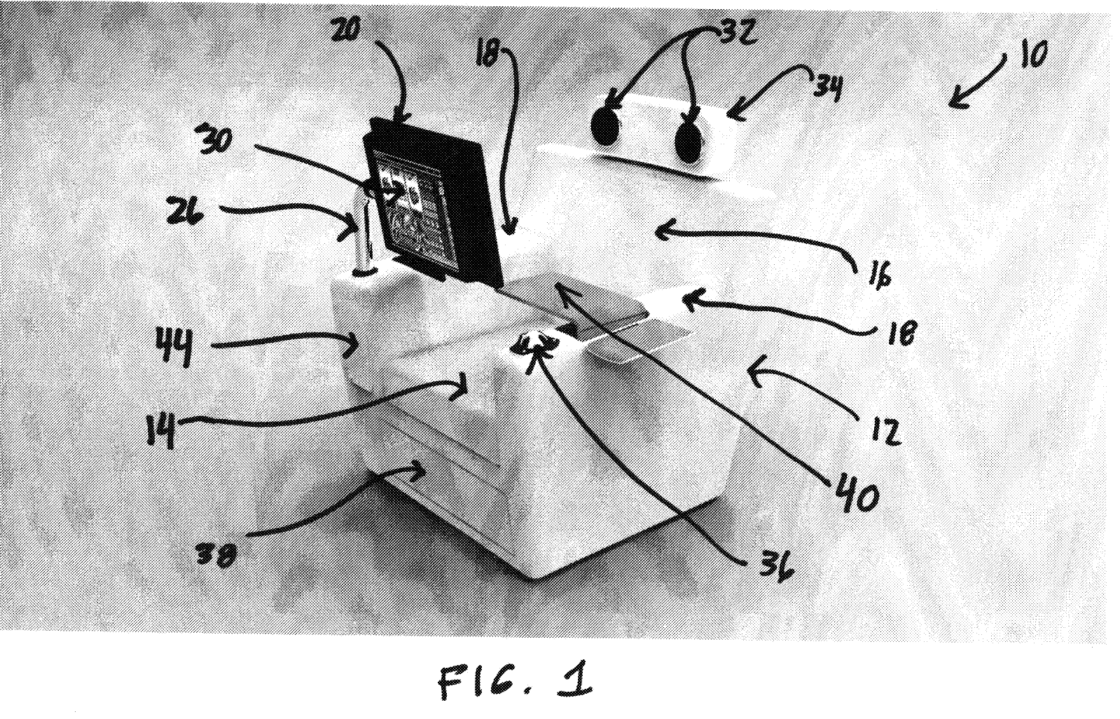

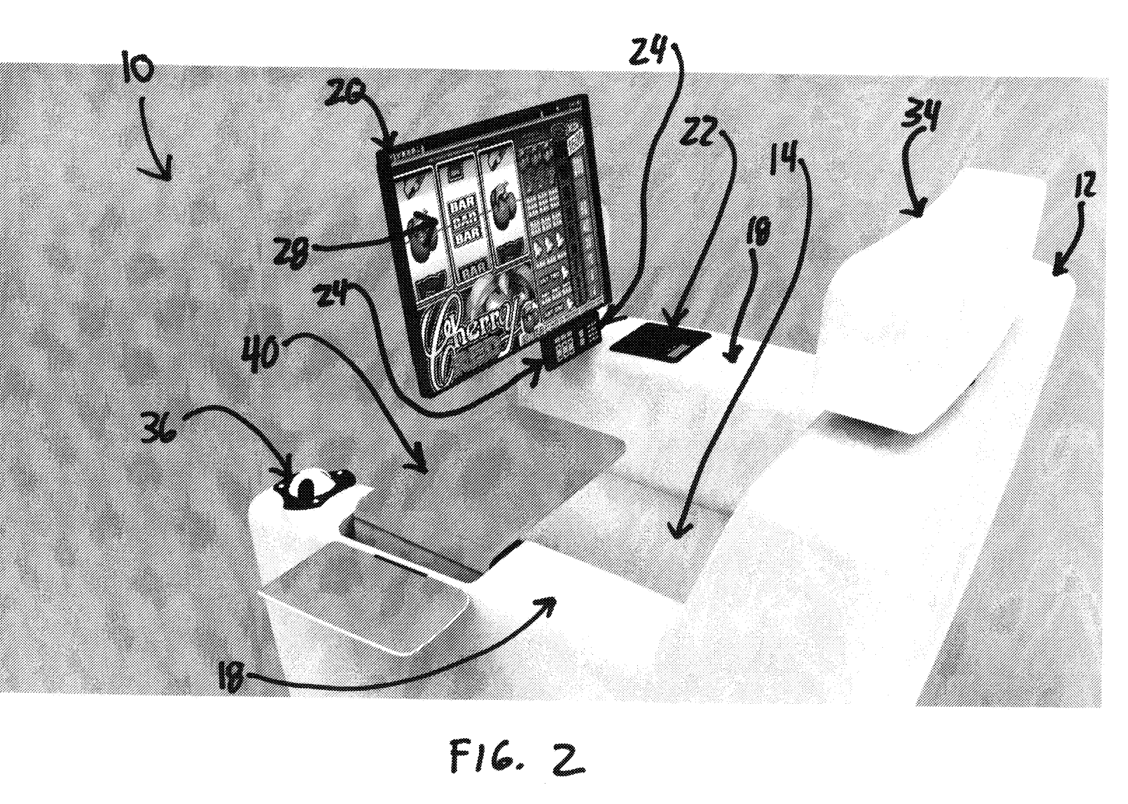

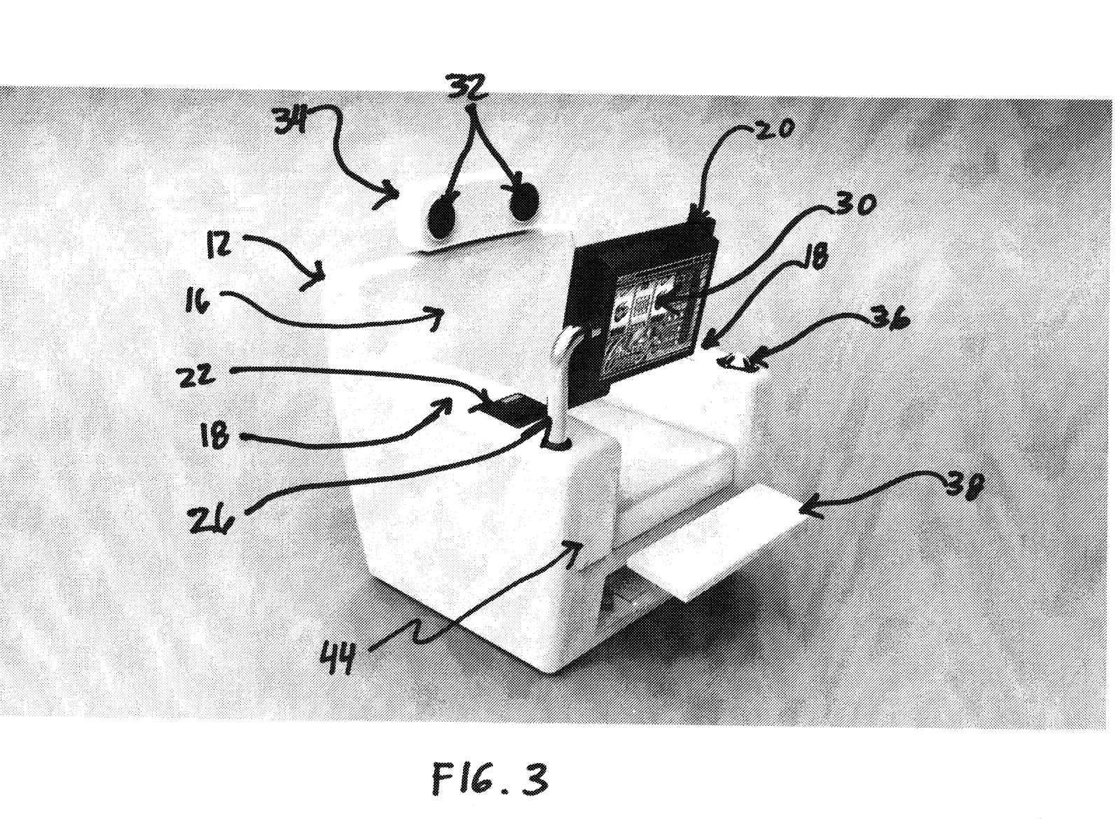

With reference to FIGS. 1-4, the present invention provides for a seated gaming device 10 comprising a chair 12 with a seat 14, a back 16, two arms 18, a monitor housing 20 attached to one of the arms 18, an arm console 22 attached to or embedded in one of the arms 18 and a detachable controller 24. The device also includes audio for the game being played as well as other functions more particularly described below. Audio could be provided through speakers placed in the monitor housing 20, through headphones jack(s) placed in the arm console 22 or elsewhere in the chair, or via dedicated surround-sound type speakers 32 placed in a head rest 34 as shown in FIGS. 1-4. The device 10 may also include such things as a smokeless ashtray 36, a retractable footrest 38, a retractable tray 40 for (laptops or food and beverage) and in-chair massage and/or heating or cooling features. The device 10 could also include wired or wireless networking allowing the player to access the Internet.

The chair 12 is preferably a lounge-type chair although other configurations are possible. The exterior surfaces of the chair may be made of plastic or other durable, easily cleaned material such as laminate or upholstery. If made of a hard material like plastic, the chair 12 may include a pillow cushion as the seat 14 as shown in FIGS. 1-4. Cushion seat, back and arm rests are preferably removeable for ease of cleaning, updating and repairs. However, the seat could be composed of plastic or another material. In other embodiments, the entire exterior surface of the chair or select portions could be upholstered. For example, the arms 18 are preferably laminate allowing for easy customization and ease of cleaning.

The monitor housing 20 is preferably attached to the arm 18 via a universal mount 26, preferably capable of rotating in multi-directions that at a minimum swivels towards the front and/or back of the chair 12 to allow the user to get into and out of the chair 12. The monitor housing 20 houses at least one player video display 28 which can be seen by the player when seated in the chair 12. The player video display 28 is preferably a touch screen device. The monitor housing 20 may also include a promotional monitor 30 which can be used to market the game to people passing by the device 10 or to display other promotional advertising within the casino. It can also be used to display progressive jackpots and the like. Either or both of the player video display 28 or the promotional monitor 30 may include a monitor ticker or crawl that scrolls along the bottom of the monitor, even during game play, to announce promotions, keno or other secondary games or messaging to the player. The player video display 28, particularly if touch screen, can be used, either via the touch screen or via the detachable controller 24, to provide secondary games to the player such as keno, bingo, sports betting and the like. A touch screen player video display 28 could also be used by the player to order beverage and food service, make dinner reservations, and see a map of the property or other like functions. The coin/bill/credit card acceptor in the arm console 22 could be used to accept wagers on secondary games and bets. The secondary games and events could be viewed on additional open windows on the player video display 28 during game play and the player video display 28 could be used to notice a win and to prompt further play. For example, a player playing a slot or video poker game on the player video display 28, could via a button on the detachable controller 24 or a button on the touch screen select to also play a game of keno or bingo or place a sports bet. An additional window could be opened on the player video display 28 allowing the player to see both the base slot or video poker game and the keno/bingo game or the sports betting options. The player could make his or her keno/bingo ticket or sports bet selections on the player video display 28 and pay for the keno/bingo game or sports bet via the coin/bill/credit card acceptor or other electronic interface in the arm console 22. While awaiting the secondary game results, the secondary game window could either remain open while the player plays the base game in the base window or the secondary game window could close and the results could be presented in a crawl at the bottom or other area of the player video display 28. In another embodiment, once the results of the secondary game are available a new window could pop-up automatically to inform the player.

The arm console 22 includes a card reader, head phone outlet and a coin/bill/credit card acceptor or other electronic payment interface. The mechanisms of the arm console 22 and access to the coins/bills accepted is provided by a lockable arm console door 44. The central processing unit and/or networking connections to control the game and other functions of the device 10 may also be located behind the arm console door 44 or elsewhere in the body of the chair 12. The device is also designed to take advantage of all forms of server based gaming. The arm console 22 could also include such items as a docking station for a player's mobile music device,

The detachable controller 24 includes a plurality of buttons and other controls to control the game and other functions of the chair. For example, dedicated buttons could be provided to allow the player to call for food and beverage service, change service or machine service. The detachable controller 24 could also include a texting keypad. The texting keypad could be used to order food and beverage or to send messages to other players that could be received on a crawl that appeared on the other players' player video display 28. In-house messaging could also be received through the speakers 32 or the headphone jack. The player could also use the texting keypad to respond to information received from casino hosts via the crawl on the player video display 28. The detachable controller 24 also could include controls to allow the player to select custom music to be played through the headphone jack or speakers 32.

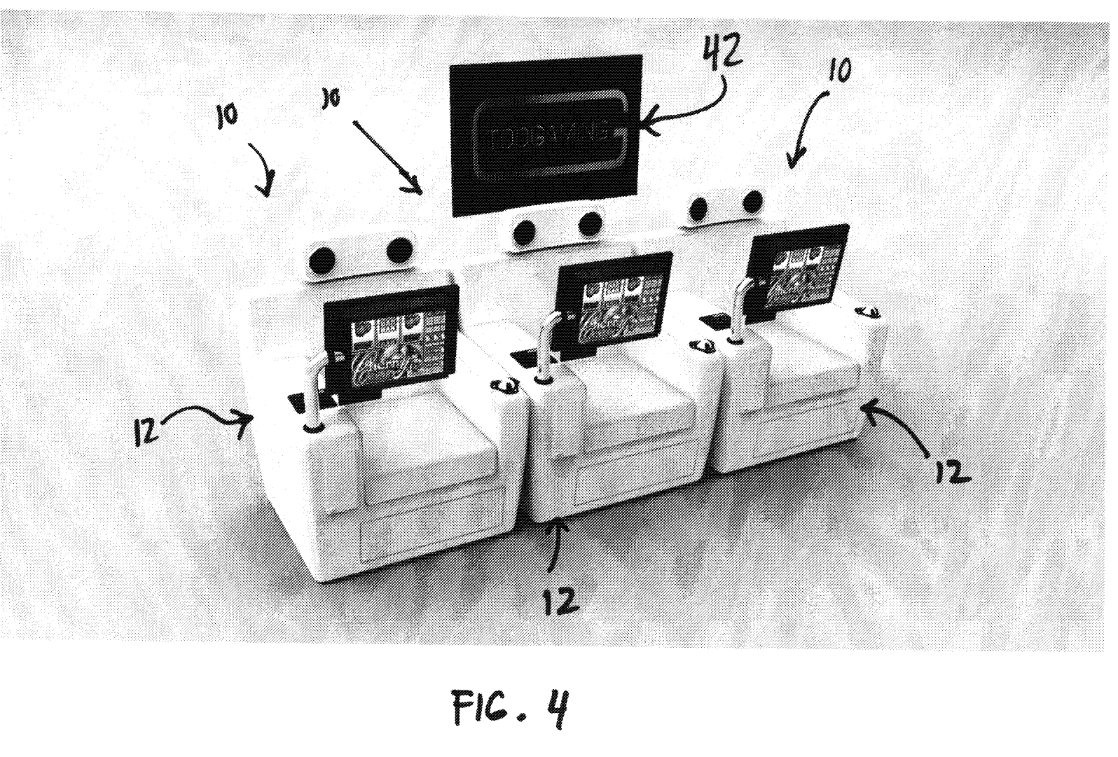

As seen in FIG. 4, the device 10 may be designed to be stacked against one another (preferably interlocking) in order to secure banks of a plurality of devices 10. In such configurations, progressive monitors 42 may be positioned above the bank of devices 10 to advertise the game and any progressives or other promotions offered. The progressive monitors 42 could also be used in competitive games played by multiple players in a bank of devices 10 to show the status of each player with respect to the other players in the bank to create a visual contest or “horse race” and excitement between the players in the bank.

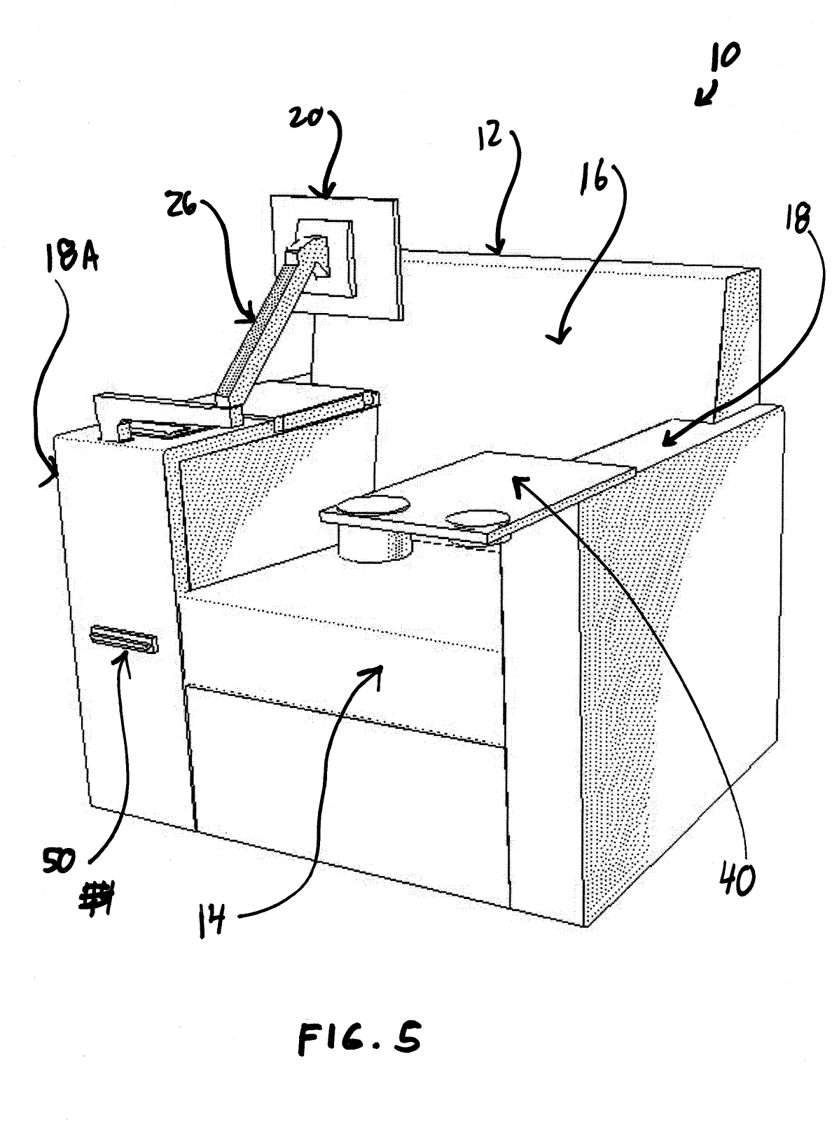

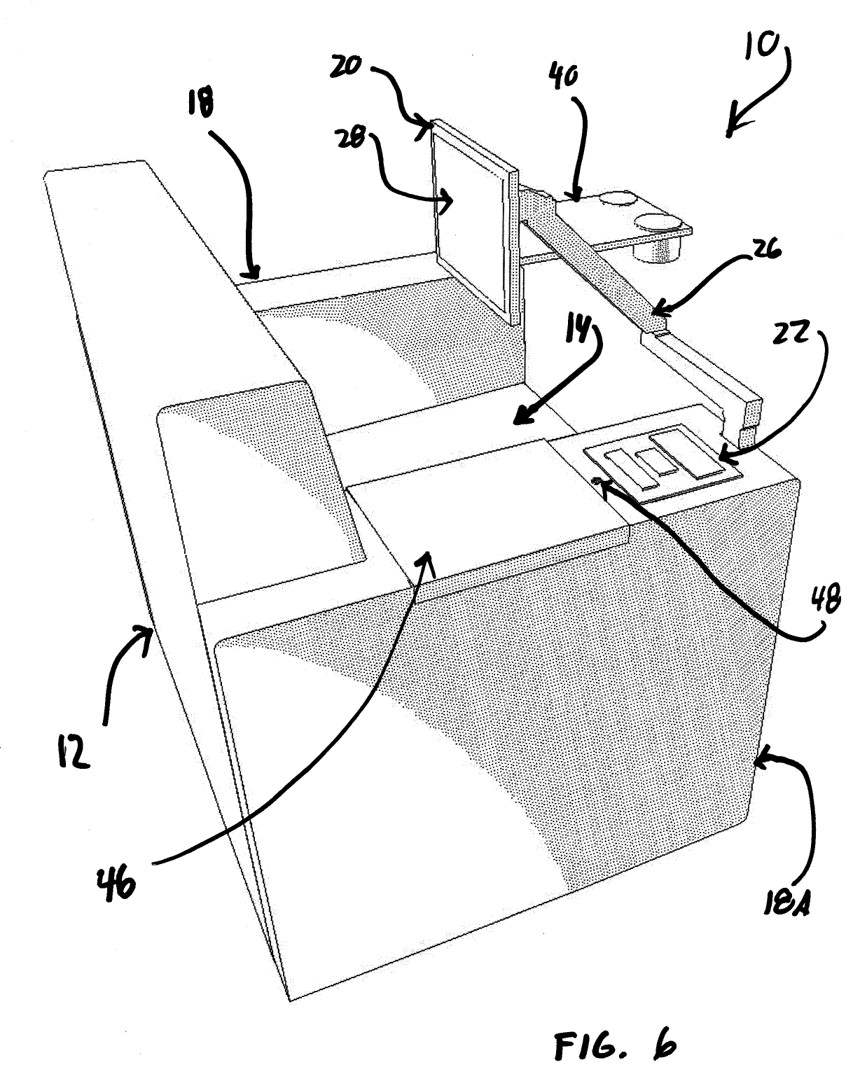

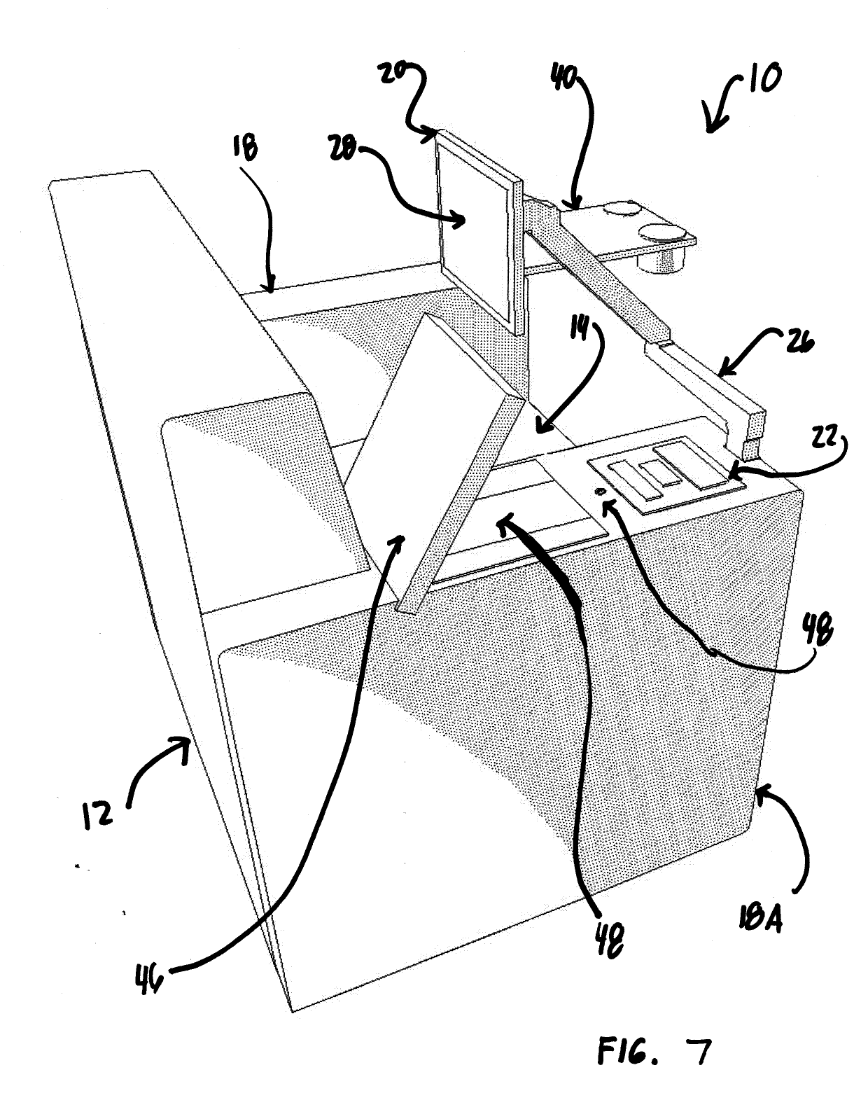

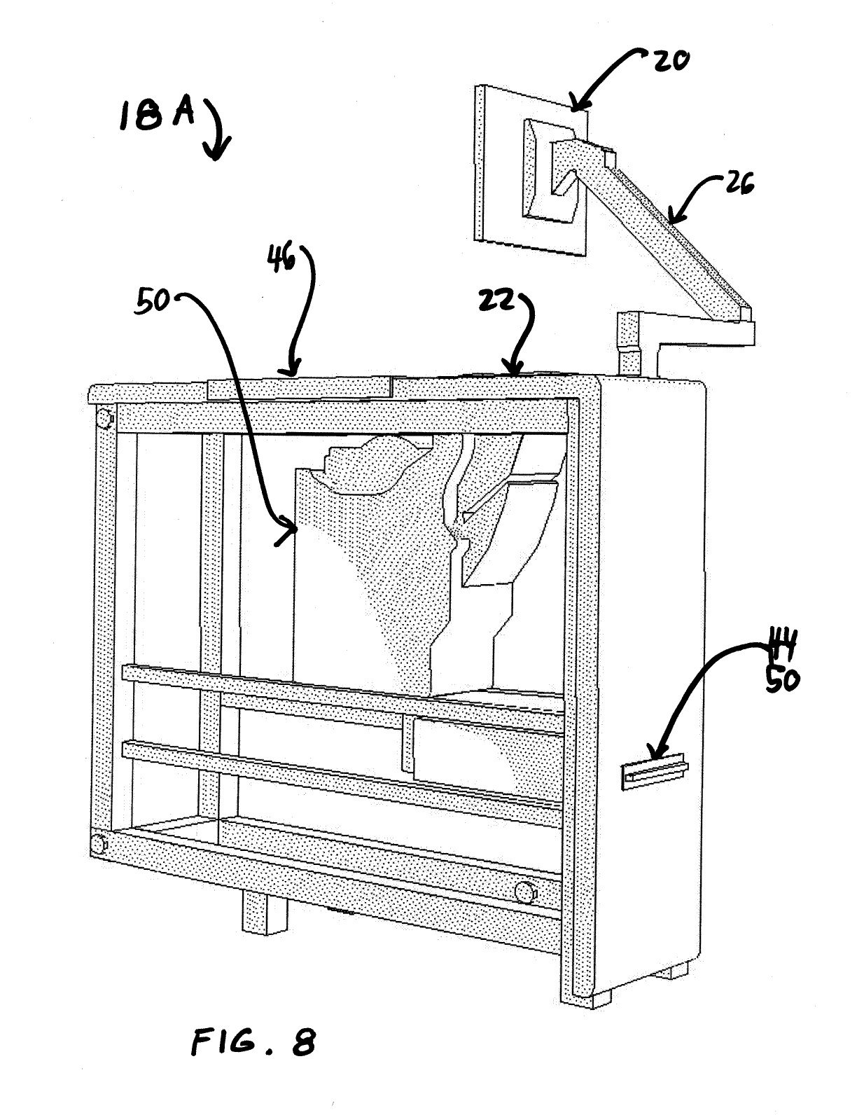

With reference to FIGS. 5-8, an embodiment of the device wherein one of the arms is a modular gaming cabinet configured to be easily removed and attached from the device is shown. As can be seen with reference to FIGS. 5-8, this embodiment may contain all the features and functions of the embodiments described above. Specifically, this embodiment provides for a seated gaming device 10 comprising a chair 12 with a seat 14, a back 16, two arms 18 and 18A, a monitor housing 20 attached to one of the arms 18A via a universal mount 26, an arm console 22 attached to or embedded in one of the arms 18A and a detachable controller 24. The device also includes audio for the game being played as well as other functions more particularly described above including but not limited to speakers, headphones jack(s), smokeless ashtray, a retractable footrest, a retractable tray 40 for (laptops or food and beverage) and in-chair massage and/or heating or cooling features. The device 10 could also include wired or wireless networking allowing the player to access the Internet.

In this embodiment one of the arms however is a detachable housing components unit 18A. In one embodiment the chair 12 could include only the detachable housing unit 18A and not have a second arm 18. This embodiment could be highly useful in a banked environment as shown in FIG. 4 to save space. Highly customizable to adapt to various casino properties' needs, the detachable housing unit 18A holds bill validators, ticketing devices, cashless gaming equipment, video displays, audio devices, and all input and output devices needed for game play. Other items as discussed in above embodiments as being part of the seated gaming device 10 may be located on or in the detachable housing components unit 18A. The detachable housing unit 18A includes shelves or other means for holding all components, computer chips, storage devices, etc., needed to play the particular manufacturer's game. It also holds bill validation equipment, coin acceptors, etc. 50. The ticket-in/ticket-out equipment 52 is preferably located on the front of the detachable housing unit 18A to allow easy access for technicians to service any printer jams or malfunctions. Thus, it can be seen that all components either necessary or desirable to provide a particular casino gambling game to a customer can be either contained within or mounted on the surface of the detachable housing unit 18A.

The detachable housing unit 18A preferably has a flip top 46 for easy access to the interior 48 of the detachable housing unit 18A and for performing the game drop function (removing coin and currency from the unit. Housed on top of the detachable housing unit 18A is a sentinel pad 22 for player tracking functions.

Although shown here in one configuration, the detachable housing component unit 18A and the chair 12 itself is highly customizable and may be configured in many different ways depending on the needs of the casino. For example, one or more universal mounts may be incorporated into the chair to attach accessories to the device. An attachment for holding purses or small bags may be included on the detachable housing component unit 18A or elsewhere on the device 10. Additionally, a second universal mount could be attached to the second arm 18. The second universal mount could be used to hold a second display or other components of the game or chair 12. Alternatively, the second universal mount could be used to hold the single display while the first universal mount on the housing component unit 18A could be used to hold other components of the game or chair 12.

Whereas the disclosure has been shown and described in connection with the preferred embodiment thereof and a few variations, many modifications, substitutions and additions may be made which are within the intended broad scope of the disclosure.

What is claimed is:

1. A gaming cabinet comprising:
a chair having a seat, a back, and at least a first arm;
said first arm being detachable from said chair and configured to support the components of a video gambling game.

2. The gaming cabinet of claim 1 further comprising a second arm, wherein said second arm is permanently attached to said chair.

3. The gaming cabinet of claim 1 wherein said seat is removable.

4. The gaming cabinet of claim 3 wherein said seat is a pillow cushion.

5. A gaming cabinet comprising:
a chair having a seat, a back, and at least a first arm, said first arm being detachable from said chair;
a video display attached to said chair;
said first arm configured to support the components of a video gambling game.

6. The gaming cabinet of claim 5 wherein said video display is attached to said first arm.

7. The gaming cabinet of claim 6 wherein said video display is rotatably attached to said first arm.

8. The gaming cabinet of claim 5 further comprising a console located on the top surface of said first arm.

9. The gaming cabinet of claim 5 further comprising an access door on the top surface of said first arm.

10. The gaming cabinet of claim 5 further comprising ticket-in/ticket out equipment located on the front surface of said first arm.

11. The gaming cabinet of claim 5 wherein said seat is a removable pillow cushion.

12. The gaming cabinet of claim 5 further comprising a second arm, wherein said second arm is permanently attached to said chair.

13. A gaming cabinet comprising:
a chair having a seat, a removable pillow cushion; a back, and at least a first arm, said first arm being detachable from said chair and being configured to support all components of a video gambling game;
a video display rotatably attached to said first arm;
a console located on the top surface of said first arm;
an access door on the top surface of said first arm; and ticket in-ticket-out equipment located on the front surface of said first arm.

14. The gaming cabinet of claim 13 further comprising a second arm, wherein said second arm is permanently attached to said chair.

15. The gaming cabinet of claim 13 further comprising cash acceptance and validation equipment located on the top surface of said first arm and contained within said first arm.

16. The gaming cabinet of claim 15 further comprising a second arm, wherein said second arm is permanently attached to said chair.
